(19) United States
(12) Patent Application Publication
(10) Pub. No.: US 2025/0193988 A1
(43) Pub. Date: Jun. 12, 2025

(54) CONTROLLING LIGHTING DEVICES AS A GROUP WHEN A LIGHT SCENE OR MODE IS ACTIVATED IN ANOTHER SPATIAL AREA

(71) Applicant: SIGNIFY HOLDING B.V., EINDHOVEN (NL)

(72) Inventor: DZMITRY VIKTOROVICH ALIAKSEYEU, EINDHOVEN (NL)

(21) Appl. No.: 18/844,446

(22) PCT Filed: Mar. 6, 2023
(86) PCT No.: PCT/EP2023/055585

§ 371 Date: Sep. 6, 2024

(30) Foreign Application Priority Data
Mar. 8, 2022 (EP) 22160780.7

(51) Int. Cl. H05B 47/175

(52) U.S. Cl. CPC H05B 47/1985; H05B 47/196

(57) ABSTRACT

A system (1) is configured to receive, via a user interface (80), user input for configuring a first light scene/mode (88) for one or more lighting devices (64-66) located in a first spatial area (81) and receive, via the user interface, further user input indicative of an addition of a group (71,75) of lighting devices located in a second spatial area outside the first spatial area to the first light scene/mode. The group is represented as a single light source in the user interface. The system is further configured to, upon activation of the first light scene/mode, control the lighting devices in the first spatial area as individual lighting devices and the group of lighting devices as a group, and upon activation of a second light scene/mode for the group, control lighting devices of the group as individual lighting devices.

### FIELD OF THE INVENTION

The invention relates to a system for controlling lighting devices to render light effects upon activation of a light scene or mode.

The invention further relates to a method of controlling lighting devices to render light effects upon activation of a light scene or mode.

The invention also relates to a computer program product enabling a computer system to perform such a method.

### BACKGROUND OF THE INVENTION

To create a more immersive experience for a user who is listening to a song being played by an audio rendering device, a lighting device can be controlled to render light effects while the audio rendering device plays the song. In this way, the user can create an experience at home which somewhat resembles the experience of a club or concert, at least in terms of lighting. These light effects are also referred to as entertainment light effects. Entertainment light effects may also be rendered to accompany video content.

Entertainment light effects may be rendered, for example, by using the Hue Sync app and Hue lighting devices. In the Hue app, lighting devices can be added to an entertainment zone/area and their locations in a room can be specified in order to render spatial entertainment light effects when the entertainment mode is active. The Hue app can also be used to define light scenes. The user is able to assign lighting devices to rooms/groups and after selecting one of the rooms/groups, the user is able to select a user-specified or predefined color palette and one or more lighting devices of the selected room/group to create the light scene. US2020/0389966 A1 also discloses a user interface for creating a light scene.

Often, people listen to music when indoor or on the move (e.g., when driving a car). However, in some situations, people also listen to music when outdoor in the garden, for example when having a barbecue party or a family dinner, or when simply relaxing outside. Thus, it might be beneficial to be able to use entertainment lighting outdoor and or use light scenes for the garden. However, it is less likely for people to have colored light in the garden, which impacts the created light experience in the garden.

WO 2005052751A2 discloses a lighting system manager. The lighting system offers a user options to create a map of a set of interfaces, lights, groups and layouts A given set of light interfaces can, for example, be mapped in different ways. For example, in a stage lighting environment, the lights on two different sides of the stage could be made part of the same map, or they could be mapped as separate maps, or zones, so that the user can author shows for the two zones together, separately, or both, depending on the situation. By clicking the group view menu on the interface, the user is offered a menu button by which the user can choose to add a group. Using the interface, a user can discover lighting systems or interfaces for lighting systems, map the layout of lighting units associated with the lighting system, and create groups of lighting units within the mapping, to facilitate authoring of shows or effects across groups of lights, rather than just individual lights. The grouping of lighting units dramatically simplifies the authoring of complex shows for certain configurations of lighting units.

### SUMMARY OF THE INVENTION

It is a first object of the invention to provide a system, which is able to enhance a light experience in certain spatial areas.

It is a second object of the invention to provide a method, which can be used to enhance a light experience in certain spatial areas.

In a first aspect of the invention, a system for controlling lighting devices to render light effects upon activation of a light scene or mode comprises a user interface, at least one transmitter, and at least one processor configured to receive, via said user interface, user input for configuring a first light scene or mode for lighting devices located in a first spatial area, add one or more lighting devices located in said first spatial area to said first light scene or mode based on said user input, receive, via said user interface, further user input indicative of an addition of a group of lighting devices located in a second spatial area outside said first spatial area to said first light scene or mode, said group being represented as a single light source in said user interface, and add said group of lighting devices to said first light scene or mode.

The at least one processor is further configured to, upon activation of said first light scene or mode, control, via said at least one transmitter, said one or more lighting devices as individual lighting devices and said group of lighting devices as a group to render first light effects determined according to said first light scene or mode, different lighting devices of said group being controlled according to light settings, wherein said light settings are the same light settings or have differences within a predefined range, and upon activation of a second light scene or mode for said group of lighting devices located in said second spatial area, control, via said at least one transmitter, one or more lighting devices of said group as individual lighting devices to render one or more second light effects determined according to said second light scene or mode.

By controlling lighting devices in the second spatial area as a group when the light scene or mode for the first spatial area is activated, the lighting devices in the second spatial area can be used to enhance the light scene or mode activated in the first spatial area. For example, when listening to music in the garden, the lighting devices which are located indoor close to the windows may also be controlled to render entertainment light effects such that the windows serve as virtual light sources. By representing this group in the user interface as a single light source, the user is able to decide whether this group should be controlled to render light effects.

The lighting devices in the group may be controlled to render the exact same light effects or there may be some minor deviations, where the size of said deviations can be limited by some set maximum value (i.e. the predefined range). When the lighting devices are controlled as individual lighting devices, there may be large deviations between their rendered light effects. The lighting devices in the second spatial area can be controlled individually when a light scene for the second spatial area is activated.

Said at least one processor may be configured to receive, via said user interface, additional user input indicative of locations of said one or more lighting devices located in said first spatial area and of a further location of said group of lighting devices as a whole, and determine said first light effects based on said locations and said further location. This makes it possible to render spatial light effects, e.g. spatial entertainment light effects in which a lighting device renders light effects determined based on a corresponding spatial region of the video content and/or a corresponding audio channel of the audio content.

Said first light scene or mode may be a new light scene and said at least one processor may be configured to receive input indicative of a color palette for said new light scene, add said color palette to said new light scene, and control, upon said activation of said new light scene, said one or more lighting devices and said group of lighting devices according to one or more colors selected from said color palette. In this way, the lighting devices in the second spatial area can be used to enhance the light scene activated in the first spatial area. The new light scene may be a static light scene or a dynamic light scene.

Said first light scene or mode may be an entertainment mode, said first light effects may be entertainment light effects relating to audio and/or video content, and said at least one processor may be configured to control said one or more lighting devices and said group of lighting devices to render said entertainment light effects while said audio and/or video content is being rendered by a rendering device. In this way, the lighting devices in the second spatial area can be used to enhance the entertainment mode activated in the first spatial area.

Said at least one processor may be configured to determine whether said first spatial area is an indoor or an outdoor spatial area and said at least one processor may be configured to represent said group as a single light source in said user interface only if said first spatial area is an outdoor spatial area. If said first spatial area is not an outdoor spatial area, said at least one processor may represent (e.g. render or show on said user interface) the lighting devices of said group as individual light sources in said user interface, for example. Controlling lighting devices in the second spatial area as a group when the light scene or mode for the first spatial area is activated is most likely to be beneficial when the first spatial area is an outdoor spatial area.

Said at least one processor may be configured to obtain location information about relative locations of said first and second spatial areas, and to determine if said second spatial area is adjacent to said first spatial area based on said location information, and said at least one processor may be configured to represent said group as a single light source in said user interface only if said second spatial area is adjacent to said first spatial area. If said second spatial area is not adjacent to said first spatial area, said at least one processor may represent (e.g. render or show on said user interface) the lighting devices of said group as individual light sources in said user interface, for example. Controlling lighting devices in the second spatial area as a group when the light scene or mode for the first spatial area is activated is typically only beneficial if the second spatial area is adjacent to the first spatial area. By representing less groups (i.e. only the groups in adjacent spatial areas) as single light sources, the user is less likely to select inappropriate groups inadvertently.

Said at least one processor may be configured to receive, via said user interface, other user input indicative of an addition of another group of lighting devices located in a third spatial area to said first light scene or mode, said other group being represented as another single light source in said user interface, add said other group of lighting devices to said first light scene or mode, and upon activation of said first light scene or mode, further control, via said at least one transmitter, said other group of lighting devices as a group to render first light effects determined according to said first light scene or mode, different lighting devices of said other group being controlled according to further light settings, wherein said further light settings are the same light settings or have differences within a predefined range.

For example, when rendering light effects to accompany music, the lighting devices that contribute to a visibility of a light effect shining through the first window may automatically be grouped and be represented and controlled as a single virtual light source, and a different group of lighting devices contributing to a second window may also be grouped but be represented and controlled differently from the first group. Selecting and grouping may be done automatically based on the room and/or zones defined in a light control application, for example.

Said at least one processor may be configured to stop controlling said group of lighting devices to render first light effects determined according to said first light scene or mode upon activation of said second light scene or mode. Thus, when lighting devices are needed to render light effects in their own spatial area, this has priority. Said at least one processor may be configured to activate said second light scene or mode based on an input signal from at least one of: a presence sensor, a timer, a light switch, and a user device, for example. For example, the system may be connected to a presence sensor and temporally 20 stop entertainment light effects from being rendered in rooms where presence is detected.

Said at least one processor may be configured to determine a usefulness of each of said lighting devices in said group to said first light scene or mode, select a subset of said group based on said usefulness of each of said lighting devices, and control said subset of lighting devices when controlling said group of lighting devices as a group to render first light effects determined according to said first light scene or mode. For example, said at least one processor may be configured to determine said usefulness of each of said lighting devices in said group to said first light scene or mode by determining a noticeability of each of said lighting devices in said group from said first spatial area. In this way, lighting devices that are not useful/noticeable, do not need to be controlled. This may be used to save energy, for example.

In a second aspect of the invention, a method of controlling lighting devices to render light effects upon activation of a light scene or mode comprises receiving, via a user interface, user input for configuring a first light scene or mode for lighting devices located in a first spatial area, adding one or more lighting devices located in said first spatial area to said first light scene or mode based on said user input, receiving, via said user interface, further user input indicative of an addition of a group of lighting devices located in a second spatial area outside said first spatial area to said first light scene or mode, said group being represented as a single light source in said user interface, and adding said group of lighting devices to said first light scene or mode.

Said method further comprises, upon activation of said first light scene or mode, controlling said one or more lighting devices as individual lighting devices and said group of lighting devices as a group to render first light effects determined according to said first light scene or mode, different lighting devices of said group being controlled according to light settings, wherein said light settings are the same light settings or have a differences within a predefined range, and upon activation of a second light scene or mode for said group of lighting devices located in said second spatial area, controlling one or more lighting devices of said group as individual lighting devices to render one or more second light effects determined according to said second light scene or mode. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling lighting devices to render light effects upon activation of a light scene or mode.

The executable operations comprise receiving, via a user interface, user input for configuring a first light scene or mode for lighting devices located in a first spatial area, adding one or more lighting devices located in said first spatial area to said first light scene or mode based on said user input, receiving, via said user interface, further user input indicative of an addition of a group of lighting devices located in a second spatial area outside said first spatial area to said first light scene or mode, said group being represented as a single light source in said user interface, and adding said group of lighting devices to said first light scene or mode.

The executable operations further comprise upon activation of said first light scene or mode, controlling said one or more lighting devices as individual lighting devices and said group of lighting devices as a group to render first light effects determined according to said first light scene or mode, different lighting devices of said group being controlled according to light settings, wherein said light settings are the same light settings or have differences within a predefined range, and upon activation of a second light scene or mode for said group of lighting devices located in said second spatial area, controlling one or more lighting devices of said group as individual lighting devices to render one or more second light effects determined according to said second light scene or mode.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 is a flow diagram of a first embodiment of the method;

FIG. 4 is a flow diagram of a second embodiment of the method;

FIG. 5 shows an example of a user interface which may be used in the method of FIG. 4;

FIG. 6 is a flow diagram of a third embodiment of the method;

FIG. 7 shows an example of a user interface which may be used in the method of FIG. 6;

FIG. 8 is a flow diagram of a fourth embodiment of the method;

FIG. 9 is a flow diagram of a fifth embodiment of the method;

FIG. 10 is a flow diagram of a sixth embodiment of the method; and

FIG. 11 is a block diagram of an exemplary data processing system for performing the method of the invention.

Corresponding elements in the drawings are denoted by the same reference numeral.

### DETAILED DESCRIPTION OF THE EMBODIMENTS

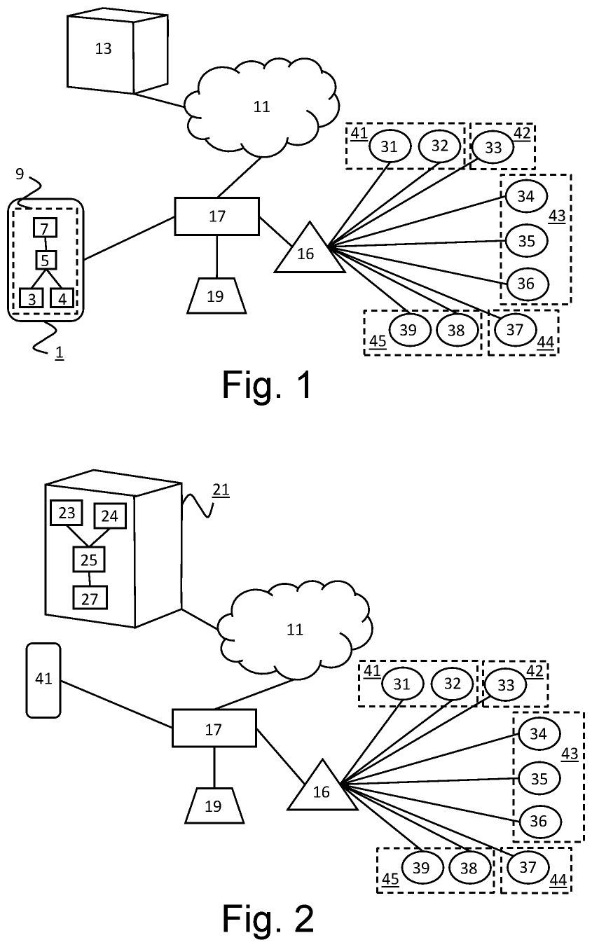

FIG. 1 shows a first embodiment of the system for controlling lighting devices to render light effects upon activation of a light scene or mode. In this first embodiment, the system is a mobile device 1. The mobile device 1 may be a smart phone or a tablet, for example. Lighting devices 31-39 can be controlled by the mobile device 1 via the bridge 16. The bridge 16 communicates with lighting devices 31-39, e.g., using Zigbee technology. The bridge 16 may be a Hue bridge, for example.

The mobile device 1, the bridge 16, and an audio rendering device 19 are connected to the wireless LAN access point 17, e.g., via Wi-Fi or Ethernet. The wireless LAN access point 17 is connected to the Internet 11. An Internet server 13 is also connected to the Internet 11. Audio and/or video content and/or light scripts may be stored on the Internet server 13, for example. One or more of the lighting devices 31-39 may be controlled to render entertainment light effects relating to audio content, e.g. specified in a light script, while the audio rendering device 19 renders the audio content.

The lighting devices 31-39 have been assigned by a user to groups which correspond to the spatial areas in which the lighting devices are located, e.g. using an app on mobile device 1. Lighting devices 31 and 32 have been assigned to a group 41 which corresponds to the living room. Lighting device 33 has been assigned to a group 42 which corresponds to the bathroom. Lighting devices 34-36 have been assigned to a group 43 which corresponds to the backyard. Lighting device 37 has been assigned to a group 44 which corresponds to bedroom 1. Lighting devices 38 and 39 have been assigned a group 45 which corresponds to bedroom 2.

The mobile device 1 comprises a receiver 3 a transmitter 4, a processor 5, a memory 7, and a touchscreen display 9. The processor 5 is configured to receive, via a user interface displayed on touchscreen display 9, user input for configuring a first light scene or mode for lighting devices located in a first spatial area, add one or more lighting devices located in the first spatial area to the first light scene or mode based on the user input, receive, via the user interface displayed on touchscreen display 9, further user input indicative of an addition of a group of lighting devices located in a second spatial area outside the first spatial area to the first light scene or mode, and add the group of lighting devices to the first light scene or mode. The group is represented as a single light source in the user interface.

The first spatial area may be the backyard, for example, and one or more of the lighting devices 34-36 may be added to the first light scene or mode. One or more of the groups 41, 42, 44, and 45 of lighting devices may then also be added to the first light scene or mode. As an example, group 41 is added to the first light scene or mode.

The processor 5 is further configured to, upon activation of the first light scene or mode, control, via the transmitter 4, the one or more lighting devices as individual lighting devices and the group of lighting devices as a group to render first light effects determined according to the first light scene or mode. Different lighting devices of the group are controlled according to the same light settings or according to light settings having differences within a predefined range. The processor 5 is further configured to, upon activation of a second light scene or mode for the group of lighting devices located in the second spatial area, control, via the transmitter 4, one or more lighting devices of the group as individual lighting devices to render one or more second light effects determined according to the second light scene or mode.

In the above-mentioned example, the second spatial area is the living room and lighting device 31 and/or lighting device 32 are controlled as individual lighting devices when the second light scene is activated, while they are controlled as a group of lighting devices when the first light scene is activated. The lighting devices in the group may be controlled to render the exact same light effects or there may be some minor deviations, where the size of said deviations can be limited by some set maximum value. When the lighting devices are controlled as individual lighting devices, there may be large deviations between their rendered light effects.

The benefit of the mobile device 1 may not only be achieved when the first spatial area is an outdoor spatial area, e.g. a garden, but may also be achieved when the first spatial area is an indoor spatial area. For example, if the building has a (partial) glass door or a (partial) glass wall between a hallway and a living room, lighting devices in the hallway could be treated and represented as a single group since individual lights might not be visible. In other words, the glass door/wall becomes a virtual light source that contributes to the (e.g. entertainment) light effects in the living room.

Thus, the benefit of the mobile device 1 may be achieved in a garden or any other room where the light from other rooms will be visible but not directly. For example, the benefit of the mobile device 1 may be achieved if the first spatial area is a living room, the second spatial area is a hallway, and these two rooms are separated by the door with a some glass parts, but is probably not achieved if the first spatial area is a dining area and the second spatial area is an open kitchen, as all light from both the dining area and the kitchen will be clearly visible.

An (other) advantage of controlling lighting devices as a group is that bandwidth may be saved if all lighting devices of the group render exactly the same light settings. In this case, all lighting devices of a group may be assigned to the same channel/address, for example. If a maximum number of channels can be used, this allows more lighting devices to be controlled. For example, if the first spatial area is a garden and there are four rooms/zones facing the garden—bedroom 1, bedroom 2, bathroom and living room, the system may be able to use four channels to control more than four lighting devices—all lighting devices in the bedroom one will get assigned to the channel one, the bedroom 2 to the channel two and so on. The system then sends light values for each channel, effectively creating four virtual lighting devices/windows. The remaining channels may be used to control the lighting devices in the garden individually.

In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g., from ARM or Qualcomm or an application-specific processor. The processor 5 of the mobile device 1 may run an Android or iOS operating system for example. The display 9 may comprise an LCD or OLED display panel, for example. The memory 7 may comprise one or more memory units. The memory 7 may comprise solid state memory, for example.

The receiver 3 and the transmitter 4 may use one or more wireless communication technologies such as Wi-Fi (IEEE 802.11) to communicate with the wireless LAN access point 17, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The mobile device 1 may further comprise a camera (not shown). This camera may comprise a CMOS or CCD sensor, for example. The mobile device 1 may comprise other components typical for a mobile device such as a battery and a power connector. The invention may be implemented using a computer program running on one or more processors.

In the embodiment of FIG. 1, lighting devices 31-39 are controlled via the bridge 16. In an alternative embodiment, one or more of lighting devices 31-39 are controlled without a bridge, e.g., directly via Bluetooth. Mobile device 1 may be connected to the Internet 11 via a mobile communication network, e.g., 5G, instead of via the wireless LAN access point 17.

FIG. 2 shows a second embodiment of the system for controlling lighting devices to render light effects upon activation of a light scene or mode. In this second embodiment, the system is a computer 21. The computer 21 is connected to the Internet 11 and acts as a server. The computer 21 may be operated by a lighting company, for example.

The computer 21 comprises a receiver 23, a transmitter 24, a processor 25, and storage means 27. The processor 25 is configured to receive, via a user interface displayed on mobile device 41, user input for configuring a first light scene or mode for lighting devices located in a first spatial area, add one or more lighting devices located in the first spatial area to the first light scene or mode based on the user input, receive, via the user interface displayed on mobile device 41, further user input indicative of an addition of a group of lighting devices located in a second spatial area outside the first spatial area to the first light scene or mode, and add the group of lighting devices to the first light scene or mode. The group is represented as a single light source in the user interface.

The processor 25 is further configured to, upon activation of the first light scene or mode, control, via the transmitter 24, the one or more lighting devices as individual lighting devices and the group of lighting devices as a group to render first light effects determined according to the first light scene or mode. Different lighting devices of the group are controlled according to the same light settings or according to light settings having differences within a predefined range. The processor 25 is further configured to, upon activation of a second light scene or mode for the group of lighting devices located in the second spatial area, control, via the transmitter 24, one or more lighting devices of the group as individual lighting devices to render one or more second light effects determined according to the second light scene or mode.

If one or more of the lighting devices 31-39 are controlled to render entertainment light effects, the computer 21 may determine the entertainment light effects based on characteristics of the audio and/or video content and capture the result in a light script which contains all light control commands that need to be sent over time for the duration of the audio and/or video content. This script is sent to the bridge 16 which plays the script in sync with the audio and/or video content that is being played.

In the embodiment of the computer 21 shown in FIG. 2, the computer 21 comprises one processor 25. In an alternative embodiment, the computer 1 comprises multiple processors. The processor 25 of the computer 21 may be a general-purpose processor, e.g., from Intel or AMD, or an application-specific processor. The processor 25 of the computer 21 may run a Windows or Unix-based operating system for example. The storage means 27 may comprise one or more memory units. The storage means 27 may comprise one or more hard disks and/or solid-state memory, for example. The storage means 27 may be used to store an operating system, applications and application data, for example.

The receiver 23 and the transmitter 24 may use one or more wired and/or wireless communication technologies such as Ethernet and/or Wi-Fi (IEEE 802.11) to communicate with the Internet 11, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 23 and the transmitter 24 are combined into a transceiver. The computer 21 may comprise other components typical for a computer such as a power connector. The invention may be implemented using a computer program running on one or more processors.

In the embodiment of FIG. 2, the computer 21 transmits data to the lighting devices 31-39 via the bridge 16. In an alternative embodiment, the computer 21 transmits data to the lighting devices 31-39 without a bridge.

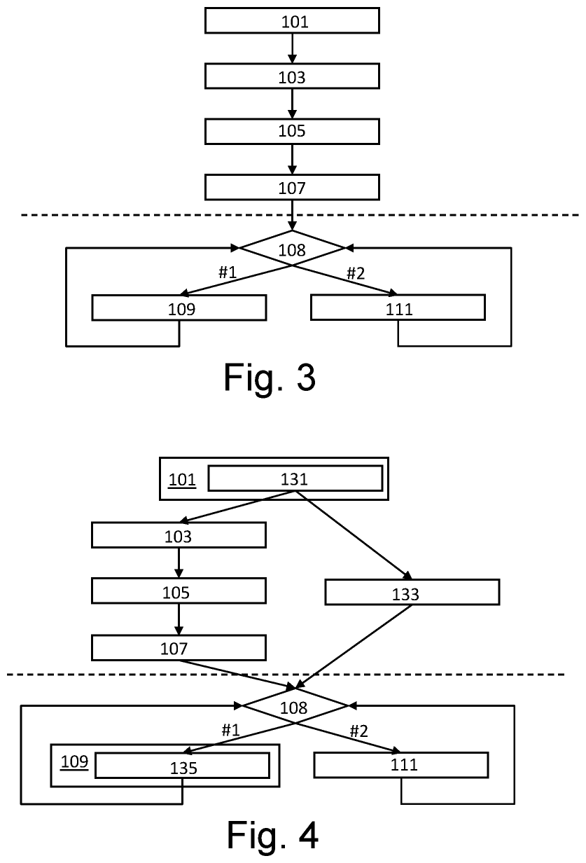

A first embodiment of the method of controlling lighting devices to render light effects upon activation of a light scene or mode is shown in FIG. 3. The method may be performed by the mobile device 1 of FIG. 1 or the (cloud) computer 21 of FIG. 2, for example.

A step 101 comprises receiving, via a user interface, user input for configuring a first light scene or mode for lighting devices located in a first spatial area. A step 103 comprises adding one or more lighting devices located in the first spatial area to the first light scene or mode based on the user input.

A step 105 comprises receiving, via the user interface, further user input indicative of an addition of a group of lighting devices located in a second spatial area outside the first spatial area to the first light scene or mode. The group is represented as a single light source in the user interface. A step 107 comprises adding the group of lighting devices to the first light scene or mode.

A step 108 comprises determining whether a light scene or mode has been activated. If it is determined in step 108 that a first light scene or mode has been activated, a step 109 is performed. If it is determined in step 108 that a second light scene or mode for lighting devices in a second spatial area outside the first spatial area has been activated, a step 111 is performed. If more than two light scene or modes have been defined, one or more additional steps similar to step 109 and/or one or more additional steps similar to step 111 may be present, and step 108 may be adapted accordingly.

Step 109 comprises controlling the one or more lighting devices as individual lighting devices and the group of lighting devices as a group to render first light effects determined according to the first light scene or mode. Different lighting devices of the group are controlled according to the same light settings or according to light settings having differences within a predefined range. The predefined range may be indicate of a maximum (allowed) difference between the light settings. The light settings may be similar to each other (but not exactly the same). The predefined range may be a threshold range. For instance, the light settings may be different shades of a certain color (e.g. different shades of blue) and/or have different intensity values, within the predefined range. Step 108 is repeated during and/or after step 109.

Step 111 comprises controlling one or more lighting devices of the group as individual lighting devices to render one or more second light effects determined according to the second light scene or mode. Step 108 is repeated during and/or after step 111.

A second embodiment of the method of controlling lighting devices to render light effects upon activation of a light scene or mode is shown in FIG. 4. The embodiment of FIG. 4 is an extension of the embodiment of FIG. 3. In the embodiment of FIG. 4, step 101 is implemented by a step 131, a step 133 is performed between steps 101 and 108, and step 109 is implemented by a step 135.

Step 131 comprises receiving, via a user interface, user input for configuring a new light scene for lighting devices located in a first spatial area. This new light scene is referred to as the first light scene. When step 131 is performed, the second light scene may already exist or may still need to be configured. In step 131, input is received indicative of a color palette for the new first light scene. This input may be part of the user input, for example. Step 133 comprises adding the color palette indicated in the input received in step 131 to the new first light scene.

Step 135 comprises controlling, upon the activation of the first light scene, the one or more lighting devices and the group of lighting devices according to one or more colors selected from the color palette added to the first light scene.

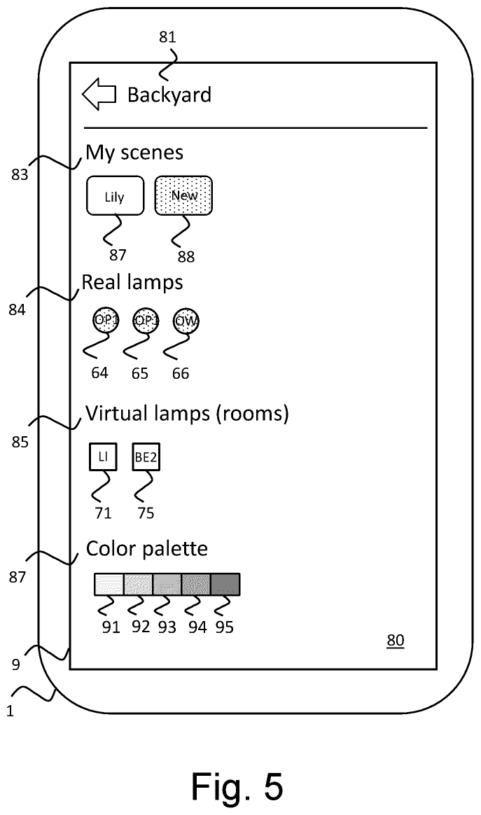

FIG. 5 shows an example of a user interface 80 of an app which may be used in the method of FIG. 4. FIG. 5 shows a screen that is displayed on a display 9 of a mobile device 1 when the user selects the spatial area “Backyard” from a list of previously defined spatial areas displayed by the app. One existing scene 87 titled “Lily” has already been defined. Existing light scenes are listed under the header 83 titled “My scenes”. The user is also able to add a new light scene 88.

In the example of FIG. 5, the user is adding a new light scene. In this case, the lighting devices assigned to the spatial area “Backyard” are listed under the header 84 titled “Real lamps”. Icons 64-66 representing three lighting devices (e.g. lighting devices 34-36 of FIG. 1) are selected by default, but may be de-selected by the user. In the example of FIG. 5, two spatial areas other than “Backyard” have previously been defined: “Living Room” and

“Bedroom 2”. Multiple lighting devices are assigned to each of these two spatial areas, but these lighting devices are not represented as individual light sources in the user interface 80. Instead, each group of lighting devices, i.e. each spatial area, is represented as a single light source: icon 71 represents the group of lighting devices in the living room (e.g. corresponding to group 41 of FIG. 1) and icon 75 represents the group of lighting devices in bedroom 2 (e.g. corresponding to group 45 of FIG. 1).

In the example of FIG. 5, the icons 71 and 75 are automatically shown when a user selects a room and then adds a scene. At that moment, the mobile device 1 shows other rooms as virtual single pixel light sources that the user could add to the scene. Alternatively, the user may need to press a virtual button (titled e.g., “Add other rooms as virtual lamps”) first, for example. The other rooms may also be represented as virtual lamps in other screens.

In addition to selecting one or more lamps in the backyard and optionally selecting one or more groups of lighting devices, the user is able to define a color palette for this new light scene. In the example of FIG. 5, the color palette 87 comprises five colors 91-95. The user may only be allowed to specify a single color palette that applies to the whole light scene or may be able to select one or more colors per real lamp 64-66 and virtual lamp 71, 75. After the new light scene has been defined, the user can name the new light scene and store the configuration in their lighting system (not shown in FIG. 5).

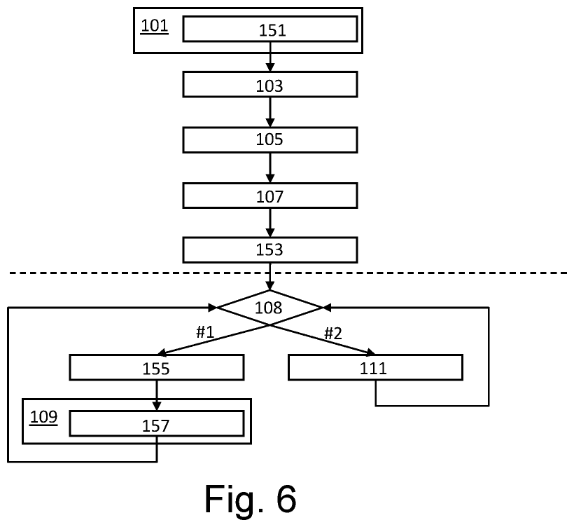

A third embodiment of the method of controlling lighting devices to render light effects upon activation of a light scene or mode is shown in FIG. 6. The embodiment of FIG. 6 is an extension of the embodiment of FIG. 3. In the embodiment of FIG. 6, step 101 is implemented by a step 151, a step 153 is performed between steps 107 and 108, and step 109 is preceded by a step 155 and implemented by a step 157.

Step 151 comprises receiving, via a user interface, user input for configuring an entertainment mode for lighting devices located in a first spatial area. A second entertainment mode or a light scene may already exist or may still need to be configured. Step 153 comprises receiving, via the user interface, additional user input indicative of locations of the one or more lighting devices located in the first spatial area and of a further location of the group of lighting devices as a whole.

If it is determined in step 108 that the (first) entertainment mode has been activated, steps 155 and 157 are performed. Step 155 comprises determining entertainment light effects based on the locations and the further location indicated in the additional user input received in step 153. In an alternative embodiment, the entertainment light effects are not determined based on the locations and/or the further location. In both cases, the entertainment light effects relate to audio and/or video content. Step 157 comprises controlling the one or more lighting devices and the group of lighting devices to render the entertainment light effects determined in step 155 while the audio and/or video content is being rendered by an audio and/or video rendering device.

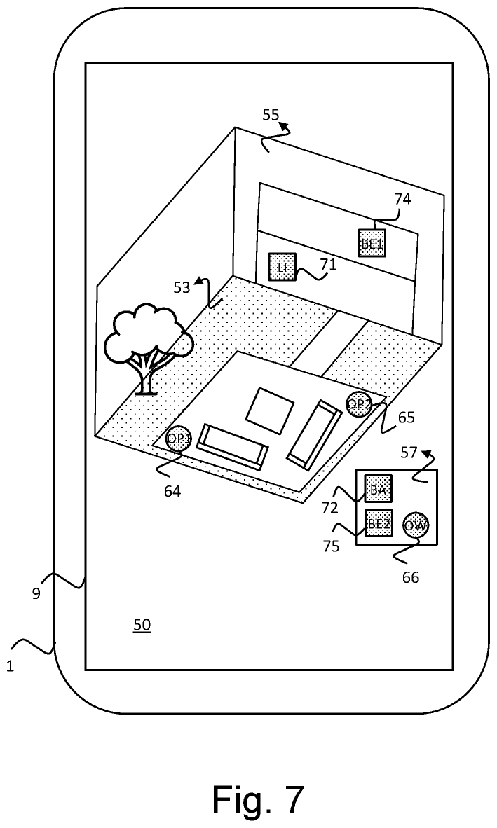

FIG. 7 shows an example of a user interface 50 of an app which may be used in the method of FIG. 6. FIG. 7 shows a screen that is displayed on a display 9 of a mobile device 1 when the user defines an outdoor entertainment zone, e.g. after the user has indicated that they want to create an entertainment zone and that the entertainment zone is for a garden. On this screen, the user is able to place real lamps located in an outdoor spatial area, e.g. backyard, in a garden representation 53. This garden representation is similar to a room representation when defining an indoor entertainment zone. The user is not only able to indicate which real lamp(s) should be controlled to render entertainment light effects but also the locations of these lamps. However, the locations of the lamps are not important for all applications.

The user is also able to indicate of which indoor spatial area(s) the corresponding group(s) of lighting devices should be controlled to render entertainment light effects. The user is able to select these group(s) of lighting devices and place them on a building (façade) representation 55 at the locations of the glass windows and/or glass doors, thereby also indicating the locations from which the light emitted by these groups will appear to come from when outside the building.

In the user interface 50, the user is able to drag icons 64-66 representing real lamps (e.g. lighting devices 34-36 of FIG. 1) from a window 57 displayed on screen to the garden representation 53 and icons 71, 72, 74, and 75 representing groups of lamps (e.g. groups 41,42, 44, and 45 of FIG. 1) from the window 57 to the building representation 55. When their icons are in the window 57, the corresponding lamps or groups of lamps are not included in the entertainment zone and do not participate in the entertainment mode. The groups 71, 72, 74, and 75 are located inside the building. The groups 71 and 75 each comprise multiple lamps. The groups 72 and 74 only comprise one lamp. The group which comprises the lighting devices represented by icons 64-66 (e.g. group 43 of lighting devices 34-36 of FIG. 1) is not represented with an icon in the user interface 50, as the icons 64-66 represent these lighting devices individually.

In the example of FIG. 7, the real lamp represented by icon 66 and the groups of lamps represented by icons 72 and 75 are not included in the entertainment zone and the corresponding lamps and groups of lamps would not be controlled to render entertainment light effects. On the other hand, icons 64 and 65 have been placed in the garden representation 53 and the icons 71 and 74 have been placed in the building representation 55 and the corresponding lamps and groups of lamps have thereby been included in the entertainment zone. The lamps corresponding to icons 64 and 65 would be controlled as individual lighting devices to render entertainment light effects and the lighting devices in the groups corresponding to icons 71 and 74 would be controlled as (two) groups to render entertainment light effects. After the outdoor entertainment zone has been defined, the user can store the configuration in their lighting system (not shown in FIG. 7).

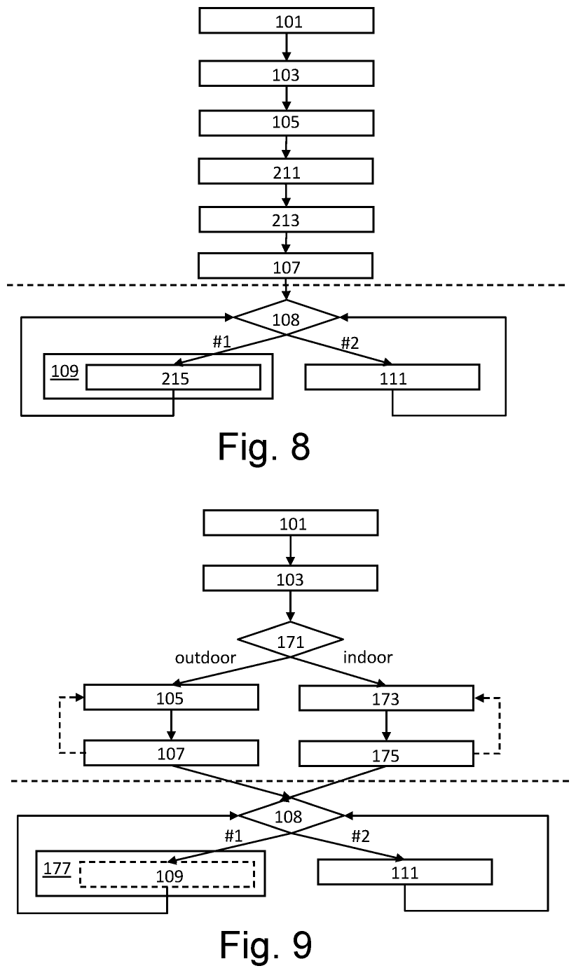

A fourth embodiment of the method of controlling lighting devices to render light effects upon activation of a light scene or mode is shown in FIG. 8. The embodiment of FIG. 8 is an extension of the embodiment of FIG. 3. In the embodiment of FIG. 8, steps 211 and 213 are performed between steps 105 and 107 and step 109 is implemented by a step 215.

Step 211 comprises determining a usefulness of each of the lighting devices in the group to the first light scene or mode. Step 211 may comprise determining the usefulness of each of the lighting devices by determining a noticeability of each of the lighting devices in the group from the first spatial area. For instance, some of the lighting devices that have minimum contribution to the light effects effect (e.g., because they are located far away from the window) may be excluded. Some of the lighting devices may also be excluded if the light effects would be bright enough when rendered by the other lighting devices in the group.

Determining a noticeability of each of the lighting devices in the group from the first spatial area may require a calibration that would include measuring changes in brightness when a specific lamp is turned on and off (e.g., using a camera). Additionally or alternatively, the uniformity of the light effects rendered by the group of lighting devices may be taken into account when determining the usefulness of each of the lighting devices. For instance, a lighting device that creates a visible spot in the window may be excluded or dimmed down.

Step 213 comprises selecting a subset of the group based on the usefulness of each of the lighting devices, as determined in step 211. Step 215 comprises controlling the subset of lighting devices to render first light effects determined according to the first light scene or mode. Different lighting devices of the subset are controlled according to the same light settings or according to light settings having differences within a predefined range.

A fifth embodiment of the method of controlling lighting devices to render light effects upon activation of a light scene or mode is shown in FIG. 9. The method may be performed by the mobile device 1 of FIG. 1 or the (cloud) computer 21 of FIG. 2, for example.

Step 101 comprises receiving, via a user interface, user input for configuring a first light scene or mode for lighting devices located in a first spatial area. Step 103 comprises adding one or more lighting devices located in the first spatial area to the first light scene or mode based on the user input received in step 101. A step 171 comprises determining whether the first spatial area is an indoor or an outdoor spatial area. Steps 105 and 107 are performed if it is determined in step 171 that the first spatial area is an outdoor spatial area. Steps 171 and 173 are performed if it is determined in step 171 that the first spatial area is an indoor spatial area.

Step 105 comprises receiving, via the user interface, further user input indicative of an addition of a group of lighting devices located in a second spatial area outside the first spatial area to the first light scene or mode. The group is represented as a single light source in the user interface. A step 107 comprises adding the group of lighting devices to the first light scene or mode. Steps 105 and 107 may be repeated one or more times to add one or more further groups of lighting devices located in a spatial area outside the first spatial area. Each group of lighting devices, and therefore each spatial area outside the first spatial area, is represented as a single light source in the user interface.

Step 173 comprises receiving, via the user interface, further user input indicative of an addition of a single lighting device located in a second spatial area outside the first spatial area to the first light scene or mode. Lighting devices outside the first spatial area are each represented as a single light source in the user interface. However, the single lighting device may still be part of a group of lighting devices located in this spatial area. Thus, the group is represented as a single light source in the user interface only if the first spatial area is an outdoor spatial area. Step 175 comprises adding the lighting device selected in step 173 to the first light scene or mode. Steps 173 and 175 may be repeated one or more times to add one or more lighting devices located in a spatial area outside the first spatial area.

Step 108 is performed after step 107 has been performed for all groups or step 175 has been performed for all lighting devices. Step 108 comprises determining whether a light scene or mode has been activated. If it is determined in step 108 that a first light scene or mode has been activated, step 177 is performed. If it is determined in step 108 that a second light scene or mode has been activated for lighting devices in a second spatial area outside the first spatial area, step 111 is performed.

Step 177 comprises controlling the one or more lighting devices in the first spatial area as individual lighting devices to render first light effects determined according to the first light scene or mode. If the first spatial area is an outdoor spatial area, each of the groups of lighting devices added in step 107 is controlled as a group in step 177 to render first light effects determined according to the first light scene or mode. Different lighting devices of the group are controlled according to the same light settings or according to light settings having differences within a predefined range. If the first spatial area is an indoor spatial area, each of the lighting devices added in step 175 is controlled as individual lighting device in step 177 to render first light effects determined according to the first light scene or mode. Step 108 is repeated during and/or after step 177.

Step 111 comprises controlling one or more lighting devices of the group of lighting devices in the second spatial area as individual lighting devices to render one or more second light effects determined according to the second light scene or mode. Step 108 is repeated during and/or after step 111.

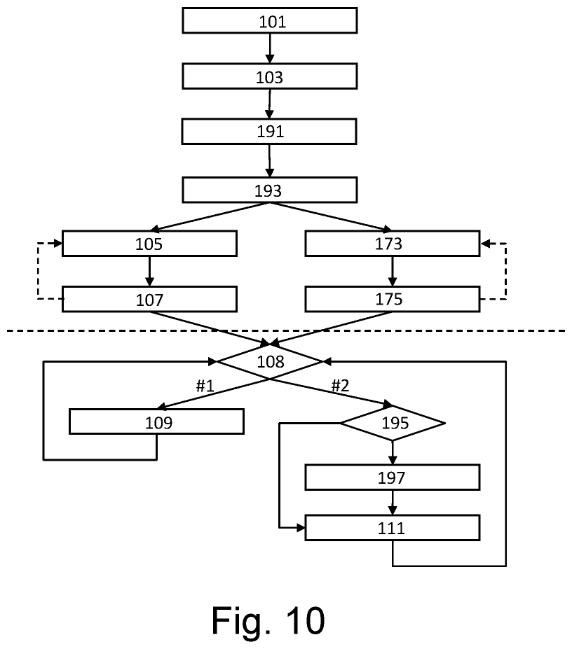

A sixth embodiment of the method of controlling lighting devices to render light effects upon activation of a light scene or mode is shown in FIG. 10. The method may be performed by the mobile device 1 of FIG. 1 or the (cloud) computer 21 of FIG. 2, for example.

Step 101 comprises receiving, via a user interface, user input for configuring a first light scene or mode for lighting devices located in a first spatial area. Step 103 comprises adding one or more lighting devices located in the first spatial area to the first light scene or mode based on this user input.

A step 191 comprises obtaining location information about relative locations of the first spatial area and spatial areas outside (i.e. other than) the first spatial area. A step 193 comprises determining which spatial areas outside the first spatial area are adjacent to the first spatial area based on the location information obtained in step 191. Steps 105 and 107 are performed for spatial areas outside the first spatial area which are adjacent to the first spatial area, if any. Steps 173 and 175 are performed for spatial areas outside the first spatial area which are not adjacent to the first spatial area, if any.

Step 105 comprises receiving, via the user interface, further user input indicative of an addition to the first light scene or mode of at least one group of lighting devices located in a spatial area outside the first spatial area which is adjacent to the first spatial area. The group is represented as a single light source in the user interface. A step 107 comprises adding this group of lighting devices to the first light scene or mode.

Step 173 comprises receiving, via the user interface, further user input indicative of an addition of at least one single lighting device located in a spatial area outside the first spatial area which is not adjacent to the first spatial area to the first light scene or mode. Lighting devices located in a spatial area outside the first spatial area are each represented as a single light source in the user interface if this spatial area is not adjacent to the first spatial area. However, the single lighting device may still be part of a group of lighting devices located in this spatial area. Thus, the group is represented as a single light source in the user interface only if the group is located in a spatial area which is adjacent to the first spatial area. Step 175 comprises adding the at least one lighting device selected in step 173 to the first light scene or mode. In an alternative embodiment, lighting devices located in a spatial area outside the first spatial area which is not adjacent to the first spatial area are not represented in the user interface.

Step 108 comprises determining whether a light scene or mode has been activated. If it is determined in step 108 that the first light scene or mode has been activated, a step 109 is performed. If it is determined in step 108 that a second light scene or mode has been activated for lighting devices in a second spatial area outside the first spatial area, a step 195 is performed. The second light scene or mode may be activated, for example, based on an input signal from a presence sensor, a timer, a light switch, or a user device. Step 109 comprises controlling the one or more lighting devices added in step 103 as individual lighting devices, any lighting devices added in step 175 as individual lighting devices, and each of the groups of lighting devices added in step 107 as a group to render first light effects determined according to the first light scene or mode. Different lighting devices of a group are controlled according to the same light settings or according to light settings having differences within a predefined range. Step 108 is repeated during and/or after step 109.

A step 195 comprises determining whether the first light scene or mode is still active. If so, a step 197 is performed. If not, step 197 is skipped and step 111 is performed next. Step 197 comprises (e.g. temporarily) stopping control of the group of lighting devices to render first light effects determined according to the first light scene or mode, i.e. stopping step 109. Step 111 is performed after step 197. Step 111 comprises controlling one or more lighting devices of the group as individual lighting devices to render one or more second light effects determined according to the second light scene or mode. Step 108 is repeated during and/or after step 111.

Multiple of the embodiments of FIGS. 3 to 4, 6, and 8 to 10 may be combined. For example, one or more of the embodiments of FIGS. 8 to 10 may be combined with the embodiment of FIG. 4 or the embodiment of FIG. 6.

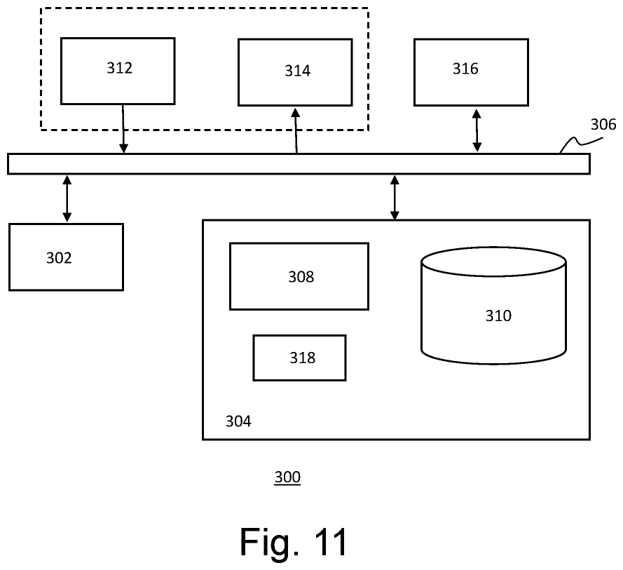

FIG. 11 depicts a block diagram illustrating an exemplary data processing system that may perform the method as described with reference to FIGS. 3 to 4, 6, and 8 to 10.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g., if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g., for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling lighting devices to render light effects upon activation of a light scene or mode, said system comprising:
a user interface;
at least one transmitter; and
at least one processor configured to:
receive, via said user interface, user input for configuring a first light scene or mode for lighting devices located in a first spatial area,
add one or more lighting devices located in said first spatial area to said first light scene or mode based on said user input,
receive, via said user interface, further user input indicative of an addition of a group of lighting devices located in a second spatial area outside said first spatial area to said first light scene or mode, said group being represented as a single light source in said user interface,
add said group of lighting devices to said first light scene or mode,
upon activation of said first light scene or mode, control, via said at least one transmitter, said one or more lighting devices as individual lighting devices and said group of lighting devices as a group to render first light effects determined according to said first light scene or mode, different lighting devices of said group being controlled according to light settings, wherein said light settings are the same light settings or have differences within a predefined range, and
upon activation of a second light scene or mode for said group of lighting devices located in said second spatial area, control, via said at least one transmitter, one or more lighting devices of said group as individual lighting devices to render one or more second light effects determined according to said second light scene or mode.

2. The system as claimed in claim 1, wherein said at least one processor is configured to:
receive, via said user interface, additional user input indicative of locations of said one or more lighting devices located in said first spatial area and of a further location of said group of lighting devices as a whole, and
determine said first light effects based on said locations and said further location.

3. The system as claimed in claim 1, wherein said first light scene or mode is a new light scene and wherein said at least one processor is configured to:
receive input indicative of a color palette for said new light scene,
add said color palette to said new light scene, and
control, upon said activation of said new light scene, said one or more lighting devices and said group of lighting devices according to one or more colors selected from said color palette.

4. The system as claimed in claim 1, wherein said first light scene or mode is an entertainment mode and said first light effects are entertainment light effects relating to audio and/or video content, and wherein said at least one processor is configured to control said one or more lighting devices and said group of lighting devices to render said entertainment light effects while said audio and/or video content is being rendered by a rendering device.

5. The system as claimed in claim 1, wherein said at least one processor is configured to determine whether said first spatial area is an indoor or an outdoor spatial area, and wherein said at least one processor is configured to represent said group as said single light source in said user interface only if said first spatial area is an outdoor spatial area.

6. The system as claimed in claim 1, wherein said at least one processor is configured to obtain location information about relative locations of said first and second spatial areas, and to determine if said second spatial area is adjacent to said first spatial area based on said location information, and wherein said at least one processor is configured to represent said group—as said single light source in said user interface only if said second spatial area is adjacent to said first spatial area.

7. The system as claimed in claim 1, wherein said at least one processor is configured to:
receive, via said user interface, other user input indicative of an addition of another group of lighting devices located in a third spatial area to said first light scene or mode, said other group being represented as another single light source in said user interface,
add said other group of lighting devices to said first light scene or mode, and
upon activation of said first light scene or mode, further control, via said at least one transmitter, said other group of lighting devices as a group to render first light effects determined according to said first light scene or mode, different lighting devices of said other group being controlled according to further light settings, wherein said further light settings are the same light settings or have a differences within a predefined range.

8. The system as claimed in claim 1, wherein said at least one processor is configured to stop controlling said group of lighting devices to render first light effects determined according to said first light scene or mode upon activation of said second light scene or mode.

9. The system as claimed in claim 8, wherein said at least one processor is configured to activate said second light scene or mode based on an input signal from at least one of: a presence sensor, a timer, a light switch, and a user device.

10. A method of controlling lighting devices to render light effects upon activation of a light scene or mode, said method comprising:
receiving, via a user interface, user input for configuring a first light scene or mode for lighting devices located in a first spatial area;
adding one or more lighting devices located in said first spatial area to said first light scene or mode based on said user input;
receiving, via said user interface, further user input indicative of an addition of a group of lighting devices located in a second spatial area outside said first spatial area to said first light scene or mode, said group being represented as a single light source in said user interface;
adding said group of lighting devices to said first light scene or mode;
upon activation of said first light scene or mode, controlling said one or more lighting devices as individual lighting devices and said group of lighting devices as a group to render first light effects determined according to said first light scene or mode, different lighting devices of said group being controlled according to light settings, wherein said light settings are the same light settings or have differences within a predefined range; and
upon activation of a second light scene or mode for said group of lighting devices located in said second spatial area, controlling one or more lighting devices of said group as individual lighting devices to render one or more second light effects determined according to said second light scene or mode.

11. A computer program product for a computing device, the computer program product comprising computer program code to perform the method of claim 10 when the computer program product is run on a processing unit of the computing device.
